(19) United States
(12) Patent Application Publication
(10) Pub. No.: US 2011/0010436 A1
(43) Pub. Date: Jan. 13, 2011

(54) CONFIGURATION-INFORMATION SETTING METHOD AND INFORMATION PROCESSING DEVICE

(75) Inventors: Hiroki Kobayashi, Kawasaki (JP); Yoshiharu Inda, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/780,314

(22) Filed: May 14, 2010

(30) Foreign Application Priority Data
Jul. 8, 2009 (JP) 2009-161654

(51) Int. Cl. G06F 15/177

(52) U.S. Cl. 709/221; 709/220

(57) ABSTRACT

According to an aspect of the embodiments, a configuration-information setting method and apparatus is provided for setting system configuration information of a computer server within an information processing device by recognizing a mounted hardware configuration in the information processing device using a computer processor within the information processing device, using the computer processor to read device configuration information of the information processing device and input-and-output configuration information of an input-and-output unit to be used in the information processing device from a storage unit and to compare device configuration information with input-and-output configuration information, and to set the system configuration information by using the computer processor when the mounted hardware configuration satisfies the device configuration information indicated in the device configuration information file and/or the input-and-output configuration information indicated in the input-and-output configuration information file.

### CROSS-REFERENCE TO RELATED APPLICATIONS

This application is based upon and claims the benefit of priority of the prior Japanese Patent Application No. 2009-161654, filed on Jul. 8, 2009, the entire contents of which are incorporated herein by reference.

### FIELD

The embodiments discussed herein are related to configuration-information setting methods and information processing devices.

### BACKGROUND

In computer systems, such as mainframes in particular, it is necessary to initialize system configuration information during initial activation of the computer system. Examples of system configuration information include information indicating whether hardware, including a central processing unit (CPU) and a memory, is set in an enabled mode or a non-enabled mode, information indicating whether input-and-output (I/O) channels are set in an enabled mode, and information related to, for example, physical mounted positions of I/O channels to be used. When activating the computer system, initialization is performed during the activation on the basis of the system configuration information.

In computer systems of the related art, it is necessary for an operator to manually set the system configuration information during initial activation of the computer system on the basis of a device configuration information file and an I/O configuration information file. A device configuration information file is a file that stores encrypted data containing the device configuration of the computer system determined in accordance with a contract made with a client (vendor/customer/user). When the computer system is in operation, this encrypted data is opened so as to activate the computer system on the basis of the device configuration determined in accordance with the contract. On the other hand, an I/O configuration information file is a file that stores configuration information of I/O units to be used in the computer system. Information in an I/O configuration information file includes, for example, channel types to be used and logical mounted positions.

FIG. 1 is a flow chart illustrating an example of a configuration-information setting method of related art. In FIG. 1, an operator installs a device configuration information file in a computer system in S1, and the operator subsequently installs I/O configuration information files in the computer system in S2. In S3, the operator selects an I/O configuration information file to be used from the installed I/O configuration information files.

In S4, the operator initializes the system configuration information on the basis of the device configuration information file and the selected I/O configuration information file. Initializing the system configuration information involves, for example, setting a CPU to be used, setting a CPU to be set on standby, setting a memory to be used, setting I/O channels to be used, setting physical mounted positions of the I/O channels to be used, and setting system options in an enabled mode or a non-enabled mode (so-called optional settings).

After S4, the operator reactivates the computer system in S5. In S6, the operator determines whether or not the system activation is successful. If the determination result in S6 is “NO”, the process proceeds to S7 where the operator determines whether or not there is an error in the initialization. If the determination result in S7 is “YES”, the process returns to S4. If the determination result in S7 is “NO”, the process proceeds to S8 where the operator determines whether or not there is an error in the selection of the I/O configuration information file. If the determination result in S8 is “YES”, the process returns to S3. If the determination result in S8 is “NO”, the process proceeds to S9 where the operator determines whether or not there is an error in the device configuration information file. If the determination result in S9 is “NO”, the process proceeds to S10 where the operator recognizes a malfunction in the hardware and determines whether to repair or replace the hardware. If the determination result in S9 is “YES”, the process proceeds to S11 where the operator re-creates a device configuration information file. On the other hand, if the determination result in S6 is “YES”, the process for setting the configuration information ends.

Since substantially the entire process for setting the configuration information is manually performed by the operator in this manner, the process is time-consuming. In addition, there is a possibility that the operator may make an operation error while setting the configuration information. Moreover, if the activation of the computer system fails due to an operation error, it is necessary to investigate the causes of the failure by, for example, checking the validity of the configuration information and the optional setting values, thus requiring time until the computer system can be restored to an operable state again.

The aforementioned problems similarly occur when the reconfiguration of the system configuration information is needed as the device configuration information file is changed.

Therefore, the configuration-information setting method and the information processing device of the related art had a problem in setting the configuration information within a relatively short time.

### SUMMARY

According to an aspect of the embodiments, a configuration-information setting method and apparatus is provided for setting system configuration information of a computer server within an information processing device by recognizing a mounted hardware configuration in the information processing device using a computer processor within the information processing device, using the computer processor to read device configuration information file indicating a device configuration of the information processing device and input-and-output configuration information file indicating configuration information of an input-and-output unit to be used in the information processing device from a storage unit and to compare device configuration information in the device configuration information file with input-and-output configuration information in the input-and-output configuration information file, and to set the system configuration information by using the computer processor when the mounted hardware configuration satisfies the device configuration information indicated in the device configuration information file and/or the input-and-output configuration information indicated in the input-and-output configuration information file. For example, the system configuration information can be one or more of information related to whether hardware is set in an enabled mode or a non-enabled mode, information related to whether an input-and-output channel is set in an enabled mode, and/or information related to a physical mounted position of the input-and-output channel to be used.

The object and advantages of the various embodiments will be realized and attained by means of the elements and combinations particularly pointed out in the claims.

It is to be understood that both the foregoing general description and the following detailed description are exemplary and explanatory and are not restrictive of the various embodiments, as claimed.

### BRIEF DESCRIPTION OF DRAWINGS

FIG. 1 is a flow chart illustrating an example of a configuration-information setting method of related art;

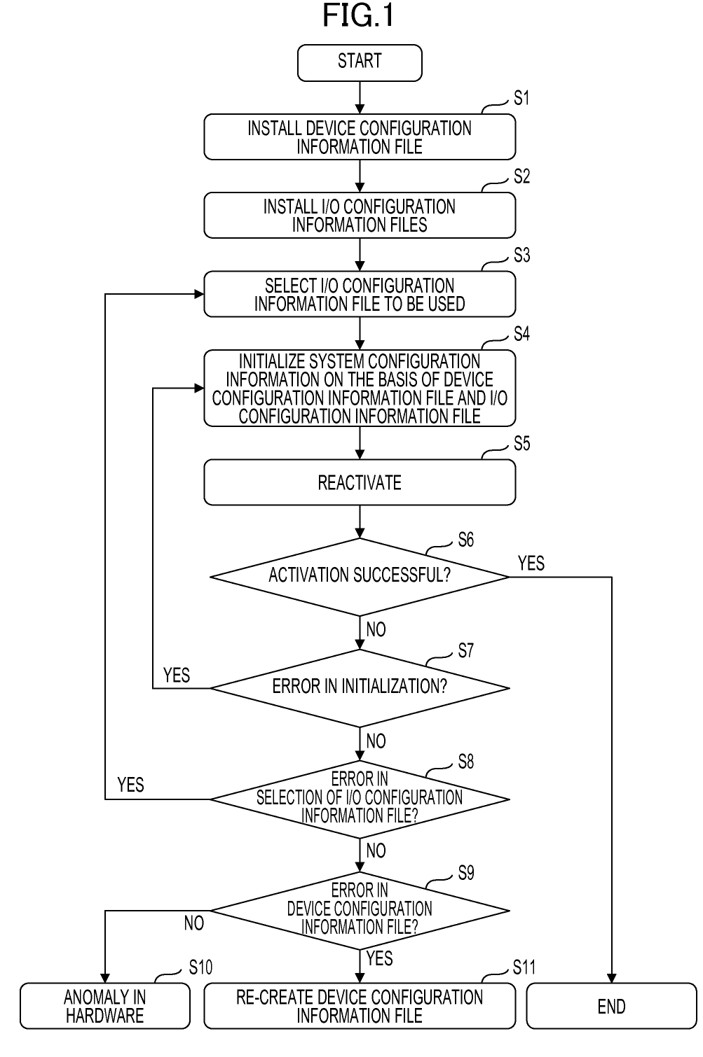

FIG. 2 is a block diagram illustrating a configuration example of an information processing device according to an embodiment of the present invention;

FIG. 3 is a block diagram illustrating a configuration example of a service processor in FIG. 2;

FIG. 4 illustrates an example of a device configuration information file;

FIG. 5 illustrates an example of an I/O configuration information file;

FIG. 6 illustrates an example of a system configuration information file;

FIG. 7 illustrates the relationship between a system configuration information file, a device configuration information file, and an I/O configuration information file;

FIG. 8 is a flow chart illustrating an example of a configuration-information setting method according to an embodiment;

FIG. 9 is a flow chart illustrating an automatic hardware-recognizing process;

FIG. 10 is a flow chart illustrating a configuration checking process; and

FIG. 11 is a timing chart partly illustrating the procedure of the configuration-information setting method.

### DETAILED DESCRIPTION OF EMBODIMENT(S)

In a configuration-information setting method and an information processing device disclosed here, system configuration information including information indicating whether hardware is set in an enabled mode or a non-enabled mode, information indicating whether input-and-output channels are set in an enabled mode, and information related to physical mounted positions of input-and-output channels to be used is set in a server within the information processing device. A processor within the information processing device automatically recognizes a mounted hardware configuration that indicates hardware mounted in the information processing device. The processor reads out a device configuration information file, which indicates the device configuration of the information processing device, and an input-and-output configuration information file, which indicates the configuration information of input-and-output units to be used in the information processing device, from a storage unit and compares recognized mounted hardware configuration with the device configuration information in the device configuration information file and/or with the input-and-output configuration information in the input-and-output configuration information file. When the mounted hardware configuration satisfies the device configuration information indicated by the device configuration information file and/or the input-and-output configuration information indicated by the input-and-output configuration information file, the processor automatically sets the system configuration information of a system configuration information file.

By automatically setting the system configuration information, the system configuration information can be set within a relatively short time, and an operation error by an operator, which may occur in the case where the system configuration information is manually set by the operator, can be prevented. In addition, automatically setting the system configuration information allows for reduction of time for setting up the information processing device in an operable state.

Embodiments of the disclosed configuration-information setting method and the disclosed information processing device will be described below with reference to the drawings.

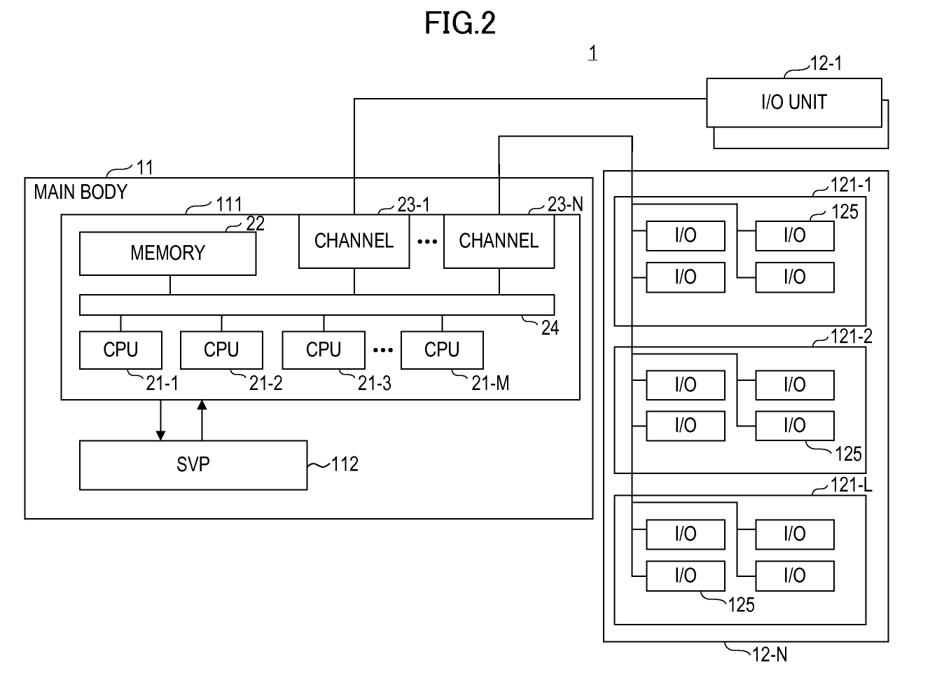

FIG. 2 is a block diagram illustrating a configuration example of an information processing device according to an embodiment of the present invention. An information processing device 1 illustrated in FIG. 2 is a so-called mainframe or a computer system and includes a main body 11 and N I/O units 12-1 to 12-N (N being a positive integer). The main body 11 includes a server 111 and a service processor (SVP) 112. Each of the I/O units 12-1 to 12-N includes, for example, L I/O modules 121-1 to 121-L (L being a positive integer). Each of the I/O modules 121-1 to 121-L is provided with a plurality of I/O portions 125.

The server 111 has a configuration in which M CPUs 21-1 to 21-M (M being a positive integer), N I/O channels 23-1 to 23-N (N being a positive integer), and a memory 22 are connected with each other via a bus 24. The M, N, and L values can be arbitrarily set and do not need to satisfy a specific relationship.

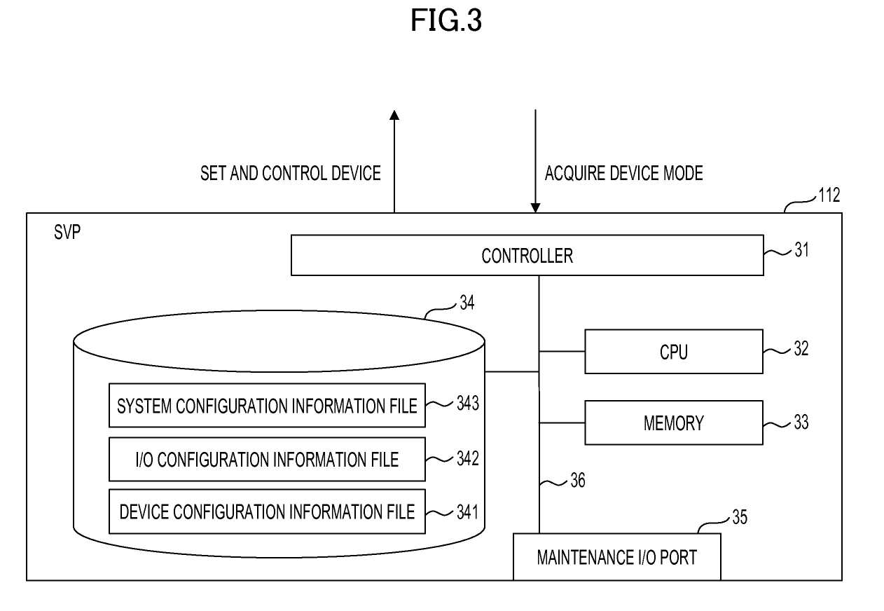

FIG. 3 is a block diagram illustrating a configuration example of the service processor 112 in FIG. 2. The service processor 112 illustrated in FIG. 3 has a configuration in which a controller 31, a CPU 32, a memory 33, a storage unit 34 formed of, for example, a hard disk drive (HDD), and a maintenance I/O port 35 are connected with each other via a bus 36. The storage unit 34 stores a device configuration information file 341, an I/O configuration information file 342, and a system configuration information file 343.

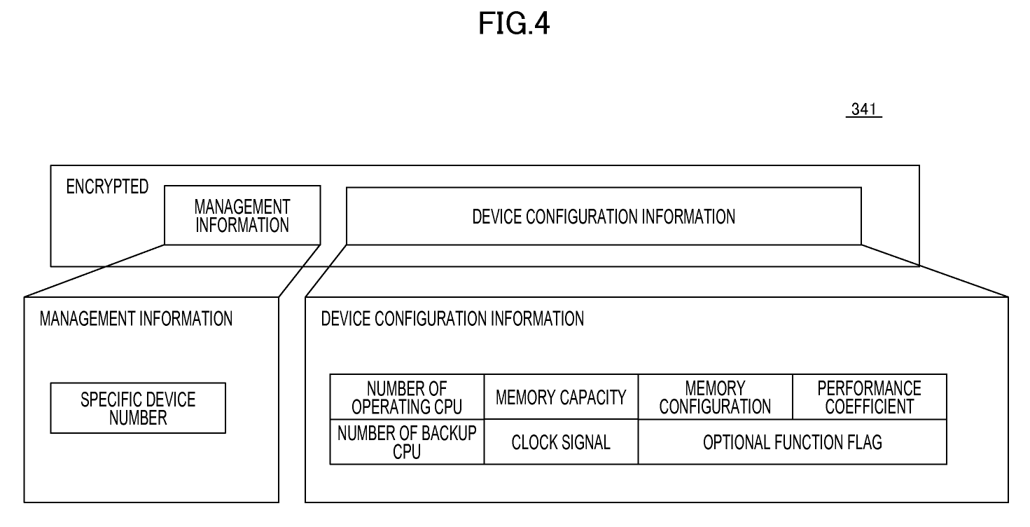

FIG. 4 illustrates an example of the device configuration information file 341. The device configuration information file 341 is a file that stores encrypted data obtained by encrypting the device configuration of the information processing device 1 determined in accordance with a contract made with a client (vendor/customer/user). When the information processing device 1 is in operation, this encrypted data is opened so as to activate the information processing device 1 on the basis of the device configuration determined in accordance with the contract. In the example illustrated in FIG. 4, management information includes, for example, a specific device number of the main body 11. Furthermore, in the example illustrated in FIG. 4, the device configuration information includes the number of operating CPUs in the CPUs 21-1 to 21-M, the memory capacity of the memory 22, the memory configuration of the memory 22, a performance coefficient indicating the performance of the server 111, the number of backup CPUs in the CPUs 21-1 to 21-M, a clock value indicating, for example, the frequency of a clock signal used within the server 111, and an optional function flag indicating an effective optional function. The management information and the device configuration information are stored in the device configuration information file 341 in the form of encrypted data.

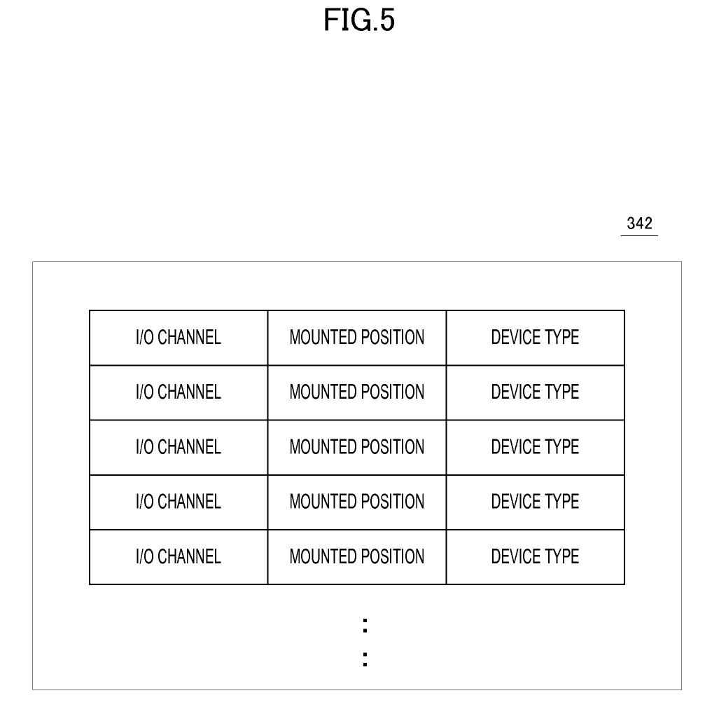

FIG. 5 illustrates an example of the I/O configuration information file 342. The I/O configuration information file 342 is a file that stores configuration information of the I/O units 12-1 to 12-N to be used in the information processing device (mainframe) 1. Information in the I/O configuration information file 342 includes, for example, types of I/O channels to be used and logical mounted positions thereof. In the example illustrated in FIG. 5, the I/O configuration information file 342 includes the logical mounted positions of the I/O channels 23-1 to 23-N with respect to the I/O channel numbers of the I/O channels 23-1 to 23-N, and the types of I/O channels 23-1 to 23-N to be used or the device types.

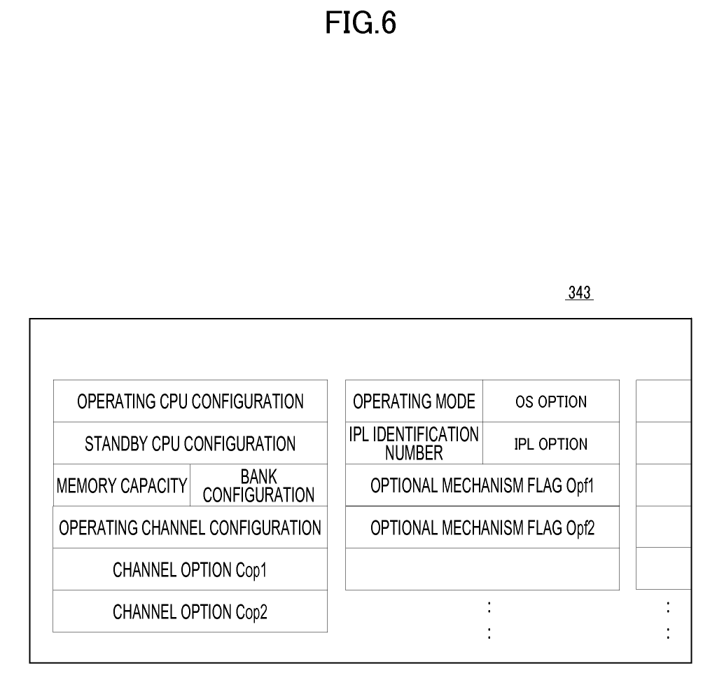

FIG. 6 illustrates an example of the system configuration information file 343. The system configuration information file 343 is a file formed of system configuration information including information indicating whether hardware, including a CPU and a memory, is set in an enabled mode or a non-enabled mode, information indicating whether I/O channels are set in an enabled mode, and information related to, for example, physical mounted positions of I/O channels to be used. In the example illustrated in FIG. 6, the system configuration information file 343 includes an operating CPU configuration constituted of operating CPUs in the CPUs 21-1 to 21-M, a standby CPU configuration constituted of CPUs to be set on standby in the CPUs 21-1 to 21-M, a memory capacity to be used in the memory 22, a bank configuration to be used in the memory 22, an operating channel configuration constituted of operating I/O channels in the I/O channels 23-1 to 23-N, channel options Cop1 and Cop2 indicating effective optional settings for the I/O channels 23-1 to 23-N, a system operating mode, optional settings of an operating system (OS), an initial-program-loader (IPL) identification number, optional settings of the IPL, and optional mechanism flags Opf1 and Opf2 indicating effective optional mechanisms.

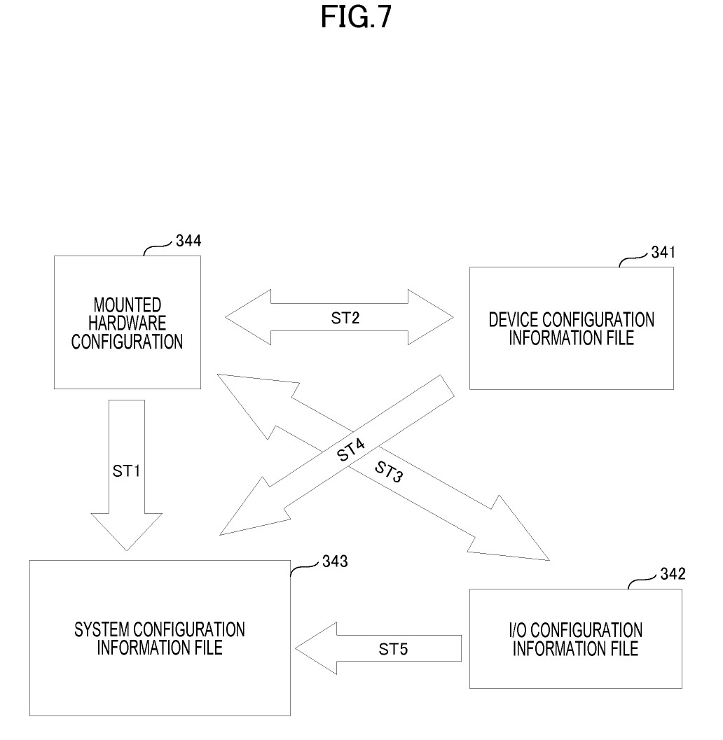

FIG. 7 illustrates the relationship between the system configuration information file 343, the device configuration information file 341, and the I/O configuration information file 342. In FIG. 7, ST1 represents that the system configuration information file 343 is set by reflecting a mounted hardware configuration 344 that indicates hardware, including a CPU, a memory, and I/O units, mounted in the information processing device 1. Furthermore, as represented by ST2, it is determined whether or not the mounted hardware configuration 344 satisfies device configuration information indicated in the device configuration information file 341. Moreover, as represented by ST3, it is determined whether or not the mounted hardware configuration 344 satisfies I/O configuration information indicated in the I/O configuration information file 342. ST4 represents that the system configuration information file 343 is set by reflecting the device configuration information indicated in the device configuration information file 341, and ST5 represents that the system configuration information file 343 is set by reflecting the I/O configuration information indicated in the I/O configuration information file 342. For example, the configuration of enabled I/O channels can be read out from the I/O configuration information file 342 so that optional setting values can be appropriately and automatically set in the system configuration information of the system configuration information file 343. When automatically setting the system configuration information, if it is determined that the mounted hardware configuration 344 does not satisfy the requirements of the device configuration information file 341 and/or the I/O configuration information file 342, the automatic setting process of the system configuration information may be discontinued and a message or the like that indicates a section lacking a hardware component may be output to the operator. In this embodiment, the above-described ST1 to ST5 are automatically executed within the service processor 112.

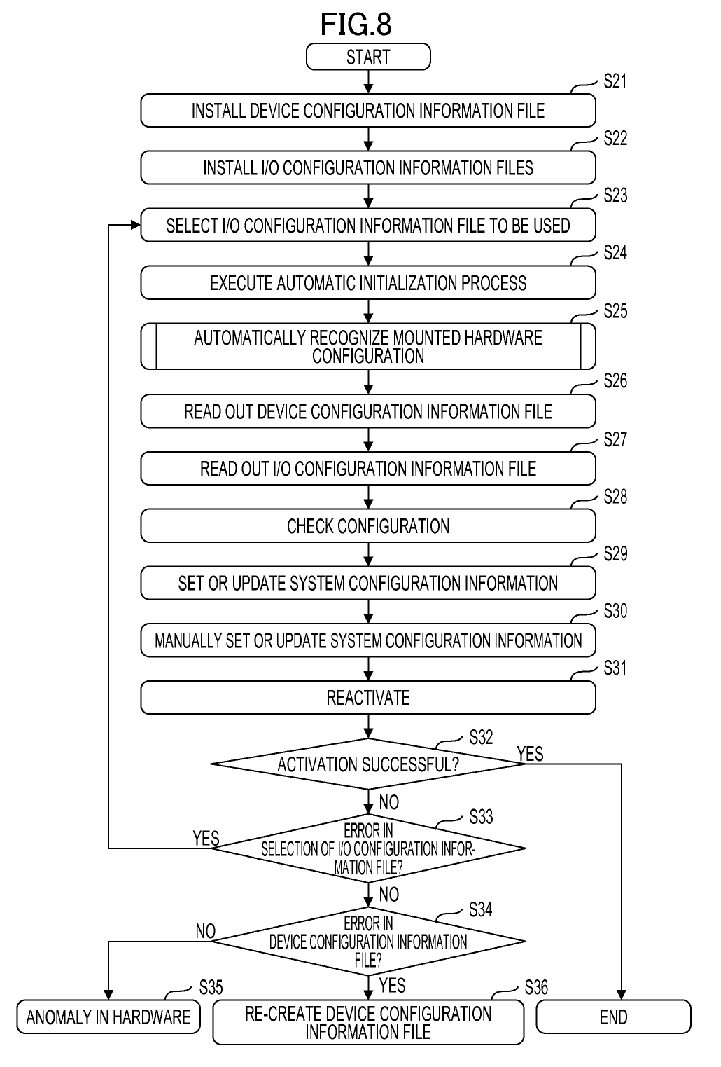

FIG. 8 is a flow chart illustrating an example of a configuration-information setting method according to an embodiment. In FIG. 8, S21 to S23 and S30 to S36 are executed in response to operation by the operator, whereas S24 to S29 are executed by the service processor 112. In this embodiment, although S25 is executed by the controller 31 and S28 is executed by the CPU 32, the modules with which S25 and S28 are to be executed are not particularly limited so long as S25 and S28 are executed within the service processor 112.

In FIG. 8, the operator installs the device configuration information file 341 in the storage unit 34 within the service processor 112 in S21. In S22, the operator installs I/O configuration information files 342 in the storage unit 34. In S23, the operator selects an I/O configuration information file to be used from the installed I/O configuration information files 342. Instructions, such as operation and selection, by the operator may be input via an operation panel or a keyboard of a freely-chosen I/O unit 12-i (i=1 to N) or may be input via an input unit (not illustrated) connected to the maintenance I/O port 35 of the service processor 112.

In S24, the service processor 112 commences an automatic initialization process. In S25, the controller 31 executes an automatic hardware-recognizing process for automatically recognizing the mounted hardware configuration 344.

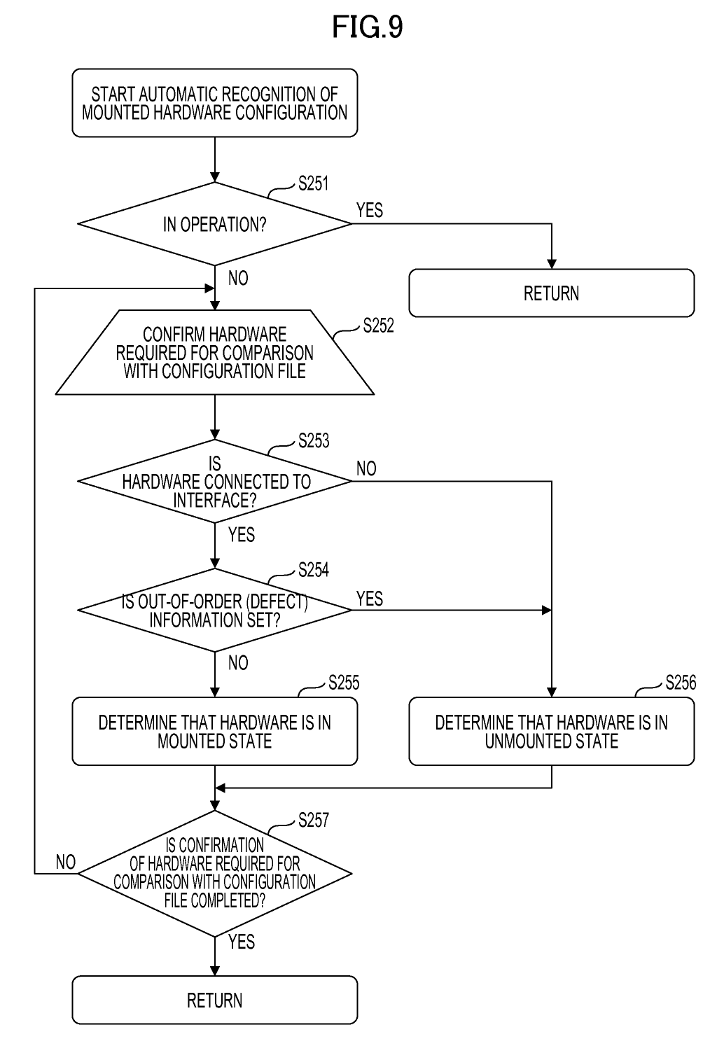

FIG. 9 is a flow chart illustrating the automatic hardware-recognizing process executed in S25. Referring to FIG. 9, it is determined in S251 whether or not the information processing device 1 is in operation. If the determination result is “YES”, the process returns to the process in FIG. 8 and proceeds to S26. On the other hand, if the determination result in S251 is “NO”, the process proceeds to S252 for confirming the hardware (such as a CPU, a memory, and I/O channels) needed for a comparison with the device configuration information in the device configuration information file 341. In S253, it is determined whether or not the hardware is connected to an interface of the server 111 by a known method, such as an interface connection test. If the determination result in S253 is “YES”, the process proceeds to S254 where it is determined whether or not information indicating that the connected hardware is out of order or defective is set. If the determination result in S254 is “NO”, the process proceeds to S255 where the hardware is determined to be in a mounted state and is stored in the mounted hardware configuration 344. If the determination result in S253 is “NO” or if the determination result in S254 is “YES”, the process proceeds to S256 where the hardware is determined to be in an unmounted state and is not stored in the mounted hardware configuration 344. After S255 or S256, the process proceeds to S257 where it is determined whether or not confirmation of all of the hardware needed for the comparison with the device configuration information in the device configuration information file 341 is completed. If the determination result in S257 is “NO”, the process returns to S252, whereas if the determination result in S257 is “YES”, the process returns to the process in FIG. 8 and proceeds to S26.

In FIG. 8, the CPU 32 reads out the device configuration information file 341 from the storage unit 34 in S26. In S27, the CPU 32 reads out the I/O configuration information file 342 from the storage unit 34. In S28, the CPU 32 executes a configuration checking process.

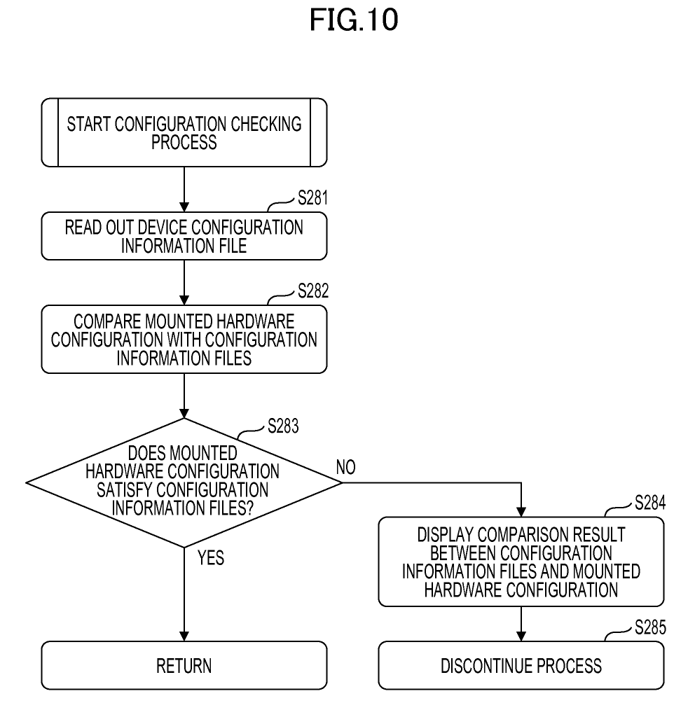

FIG. 10 is a flow chart illustrating the configuration checking process executed in S28. Referring to FIG. 10, in S281, the device configuration information file 341 is read out from the storage unit 34. In S282, the mounted hardware configuration 344 recognized in the automatic hardware-recognizing process in FIG. 9 is compared with the device configuration information in the device configuration information file 341 and/or with the I/O configuration information in the I/O configuration information file 342. In S283, it is determined whether or not the mounted hardware configuration 344 satisfies the device configuration information indicated in the device configuration information file 341 and/or the I/O configuration information indicated in the I/O configuration information file 342. If the determination result in S283 is “NO”, the process proceeds to S284 where the comparison result between the mounted hardware configuration 344 and/or the device configuration information indicated in the device configuration information file 341 and/or the I/O configuration information indicated in the I/O configuration information file 342 is displayed. The comparison result indicates, for example, a section lacking a hardware component. Such a comparison result may be displayed on a display portion of a freely-chosen I/O unit 12-i (i=1 to N) or may be displayed on a display unit (not illustrated) connected to the maintenance I/O port 35 of the service processor 112. In S285, the process in FIG. 8 is discontinued. On the other hand, if the determination result in S283 is “YES”, the process returns to the process in FIG. 8 and proceeds to S29.

Referring to FIG. 8, in S29, the CPU 32 sets or updates the system configuration information of the system configuration information file 343 and displays a message or the like indicating that the automatic initialization process is completed so as to inform the operator about the completion of the automatic initialization process. The message or the like may be displayed on any display portion of I/O unit 12-i (i=1 to N) or may be displayed on the display unit (not illustrated) connected to the maintenance I/O port 35 of the service processor 112. If necessary, in S30, the operator may manually set or update the system configuration information of the system configuration information file 343. This S30 is omittable.

After S30 or after S29 in the case where S30 is omitted, the process proceeds to S31 where the operator reactivates the information processing device 1. In S32, the operator determines whether or not the activation of the information processing device 1 is successful. If the determination result in S32 is “NO”, the process proceeds to S33 where the operator determines whether or not there is an error in the selection of the I/O configuration information file 342. If the determination result in S33 is “YES”, the process returns to S23. If the determination result in S33 is “NO”, the process proceeds to S34 where the operator determines whether or not there is an error in the device configuration information file 341. If the determination result in S34 is “NO”, the process proceeds to S35 where the operator recognizes a malfunction in the hardware and determines a repair or replacement of the hardware. If the determination result in S34 is “YES”, the process proceeds to S36 where the operator re-creates a device configuration information file 341. On the other hand, if the determination result in S32 is “YES”, the process for setting the configuration information ends.

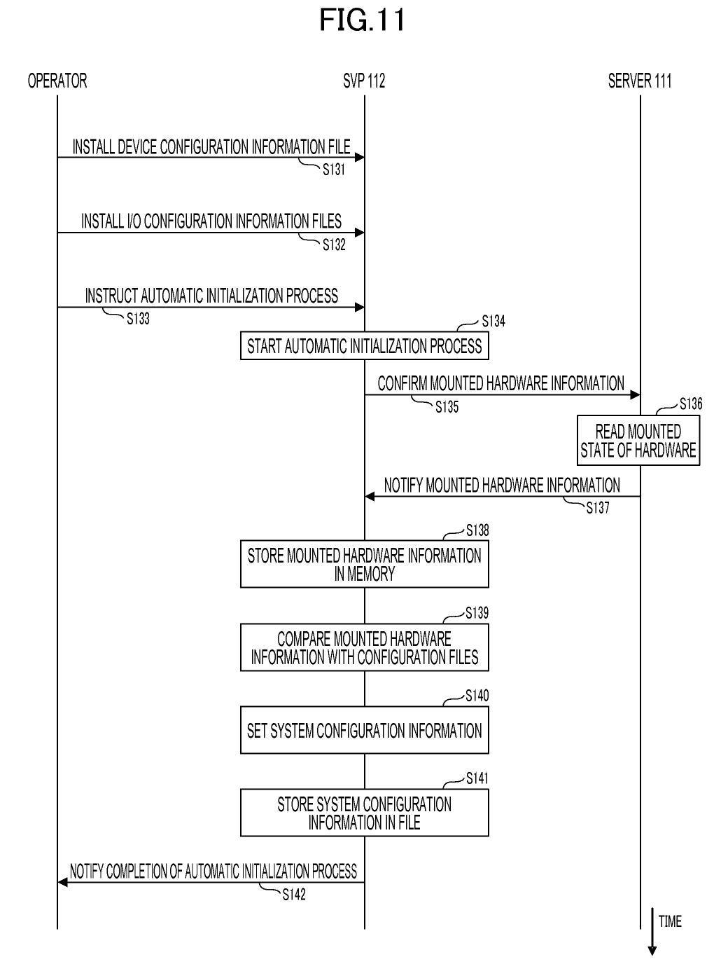

FIG. 11 is a timing chart partly illustrating the procedure of the configuration-information setting method. Referring to FIG. 11, in S131, the operator installs the device configuration information file 341 in the storage unit 34 within the service processor 112. In S132, the operator installs I/O configuration information files 342 in the storage unit 34. In S133, the operator selects an I/O configuration information file to be used from the installed I/O configuration information files 342 and instructs an automatic initialization process. In S134, the service processor 112 commences the automatic initialization process. S131 to S134 respectively correspond to those of S21 to S24 illustrated in FIG. 8.

In S135, the controller 31 of the service processor 112 confirms the mounted state of the hardware for automatically recognizing the mounted hardware configuration 344. In S136, it is determined whether or not the hardware is connected to the interface of the server 111 by a known method, such as an interface connection test, so as to read out the mounted state of the hardware in the information processing device 1. In S137, the controller 31 of the service processor 112 is notified of the mounted state of the hardware read out in S136. In S138, the controller 31 of the service processor 112 stores mounted hardware information indicating the mounted state of the hardware, that is, the mounted hardware configuration 344, in the memory 33. S135 to S138 correspond to S25 illustrated in FIG. 8.

In S139, if the information processing device 1 is in operation and/or not in operation, the CPU 32 reads out the device configuration information file 341 and/or the I/O configuration information file 342 from the storage unit 34 and also reads out the mounted hardware configuration 344 from the memory 33. Moreover, in S139, the CPU 32 compares the read and/or detected mounted hardware configuration 344 with the device configuration information in the device configuration information file 341 and/or with the I/O configuration information in the I/O configuration information file 342. In S140, when the mounted hardware configuration 344 satisfies the device configuration information indicated in the device configuration information file 341 and/or the I/O configuration information indicated in the I/O configuration information file 342, the CPU 32 sets or updates the system configuration information of the system configuration information file 343. In S141, the CPU 32 stores the set or updated system configuration information of the system configuration information file 343 into the storage unit 34. In S142, the CPU 32 displays a message or the like indicating that the automatic initialization process is completed so as to inform the operator of the completion of the automatic initialization process. The message or the like may be displayed on any display portion of I/O unit 12-i (i=1 to N) or may be displayed on the display unit (not illustrated) connected to the maintenance I/O port 35 of the service processor 112. S139 corresponds to S26, S27, and S28 illustrated in FIG. 8, and S140 to S142 correspond to S29 illustrated in FIG. 8.

Therefore, according to an aspect of the embodiments of the invention, any combinations of one or more of the described features, functions, operations, and/or benefits can be provided. A combination can be one or a plurality. The embodiments can be implemented as an apparatus (a machine) that includes computing hardware (i.e., computing apparatus), such as (in a non-limiting example) any computer that can store, retrieve, process and/or output data and/or communicate (network) with other computers. According to an aspect of an embodiment, the described features, functions, operations, and/or benefits can be implemented by and/or use computing hardware and/or software. The apparatus (e.g., the information processing device 1, the SVP 112, . . . , etc.) comprises a computer processor (CPU) (e.g., a hardware logic circuitry based computer processor that processes or executes instructions, namely software/program), computer readable recording media, transmission communication media interface (network interface), and/or a display device, all in communication through a data communication bus. In addition, an apparatus can include one or more apparatuses in computer network communication with each other or other apparatuses. In addition, a computer processor can include one or more computer processors in one or more apparatuses or any combinations of one or more computer processors and/or apparatuses. An aspect of an embodiment relates to causing one or more apparatuses and/or computer processors to execute the described operations. The results produced can be displayed on the display.

A program/software implementing the embodiments may be recorded on computer-readable recording media. Examples of the computer-readable recording media include a magnetic recording apparatus, an optical disk, a magneto-optical disk, and/or volatile and/or non-volatile semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), DVD-ROM, DVD-RAM (DVD-Random Access Memory), BD (Blue-ray Disk), a CD-ROM (Compact Disc-Read Only Memory), and a CD-R (Recordable)/RW.

The program/software implementing the embodiments may also be included/encoded as a data signal and transmitted over transmission communication media. A data signal moves on transmission communication media, such as wired network or wireless network, for example, by being incorporated in a carrier wave. The data signal may also be transferred by a so-called baseband signal. A carrier wave can be transmitted in an electrical, magnetic or electromagnetic form, or an optical, acoustic or any other form.

Although embodiments of the disclosed configuration-information setting method and the disclosed information processing device have been described above, the present invention is not limited to the above embodiments, and it is needless to say that various changes and modifications are permissible within the scope of the invention.

All examples and conditional language recited herein are intended for pedagogical objects to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A configuration-information setting method for setting system configuration information in a computer server within an information processing device, the system configuration information including one or more of information related to one or more of whether hardware is set in an enabled mode or a non-enabled mode, information related to whether an input-and-output channel is set in an enabled mode, and information related to a physical mounted position of the input-and-output channel to be used, the configuration-information setting method comprising:
recognizing a mounted hardware configuration indicating the hardware mounted in the information processing device by using a computer processor within the information processing device;
using the computer processor reading device configuration information file indicating a device configuration of the information processing device and/or an input-and-output configuration information file indicating configuration information of an input-and-output unit to be used in the information processing device from a storage unit;
comparing the recognized mounted hardware configuration with the device configuration information in the device configuration information file and/or with the input-and-output configuration information in the input-and-output configuration information file; and
setting the system configuration information of a system configuration information file by using the computer processor when the mounted hardware configuration satisfies the device configuration information indicated in the device configuration information file and/or the input-and-output configuration information indicated in the input-and-output configuration information file.

2. The configuration-information setting method according to claim 1, wherein when recognizing the mounted hardware configuration, the mounted hardware configuration is automatically recognized by causing the computer processor to perform a connection test of an interface with respect to the computer server.

3. The configuration-information setting method according to claim 1, wherein the device configuration information file stores the device configuration of the information processing device determined in accordance with a contract made with a customer client, and
wherein the input-and-output configuration information file stores the configuration information of the input-and-output unit to be used in the information processing device and includes a channel type to be used and a logical mounted position.

4. The configuration-information setting method according to claim 1, wherein the computer processor stores the set system configuration information of the system configuration information file in the storage unit.

5. The configuration-information setting method according to claim 1, wherein the mounted hardware configuration is recognized by a controller within the computer processor, and
wherein a central processing unit within the computer processor executes the comparing of the recognized mounted hardware configuration with the device configuration information in the device configuration information file and/or with the input-and-output configuration information in the input-and-output configuration information file and sets the system configuration information of the system configuration information file.

6. The configuration-information setting method according to claim 5, wherein when recognizing the mounted hardware configuration, the controller stores the mounted hardware configuration in a memory within the computer processor.

7. The configuration-information setting method according to claim 1, wherein the computer processor notifies that an automatic setting process of the system configuration information is completed.

8. The configuration-information setting method according to claim 1, wherein when setting the system configuration information of the system configuration information file, a configuration of the input-and-output channel to be used is read from the input-and-output configuration information file and an optional setting value is set in the system configuration information of the system configuration information file.

9. The configuration-information setting method according to claim 1, wherein when the mounted hardware configuration is determined as not satisfying requirements of the device configuration information file and/or the input-and-output configuration information file on the basis of a comparison of the recognized mounted hardware configuration with the device configuration information in the device configuration information file and/or the input-and-output configuration information in the input-and-output configuration information file, a setting process of the system configuration information is discontinued and a message indicating a section lacking a hardware component is output.

10. An information processing device in which system configuration information is set, the system configuration information including one or more of information related to whether hardware is set in an enabled mode or a non-enabled mode, information related to whether an input-and-output channel is set in an enabled mode, and information related to a physical mounted position of the input-and-output channel to be used, the information processing device comprising:
a recognizing portion that automatically recognizes a mounted hardware configuration indicating the hardware mounted in the information processing device;
a storage unit that stores a device configuration information file indicating a device configuration of the information processing device and an input-and-output configuration information file indicating configuration information of an input-and-output unit to be used in the information processing device;
a comparing portion that reads the device configuration information file and/or the input-and-output configuration information file from the storage unit and compares the recognized mounted hardware configuration with the device configuration information in the device configuration information file and/or with input-and-output configuration information in the input-and-output configuration information file; and
a setting portion that automatically sets the system configuration information of a system configuration information file when the mounted hardware configuration satisfies the device configuration information indicated in the device configuration information file and/or the input-and-output configuration information indicated in the input-and-output configuration information file.

11. The information processing device according to claim 10, wherein the recognizing portion is formed of a computer processor provided within the information processing device and automatically recognizes the mounted hardware configuration by performing a connection test of an interface with respect to a computer server within the information processing device.

12. The information processing device according to claim 10, wherein the device configuration information file stores encrypted data containing the device configuration of the information processing device determined in accordance with a contract made with a customer client, the encrypted data being opened when the information processing device is in operation so as to activate the information processing device on the basis of the device configuration determined in accordance with the contract, and
wherein the input-and-output configuration information file stores the configuration information of the input-and-output unit to be used in the information processing device and includes a channel type to be used and a logical mounted position.

13. The information processing device according to claim 10, wherein the setting portion is formed of a computer processor provided within the information processing device, and
wherein the computer processor stores the system configuration information of the system configuration information file set by the setting portion into the storage unit.

14. The information processing device according to claim 10, wherein the recognizing portion is formed of a controller within a computer processor, and
wherein the comparing portion and the setting portion are formed of a central processing unit within the computer processor.

15. The information processing device according to claim 14, wherein the recognizing portion of the controller stores the mounted hardware configuration in a memory within the computer processor.

16. The information processing device according to claim 10, wherein the setting portion of the computer processor notifies that an automatic setting process of the system configuration information is completed.

17. The information processing device according to claim 10, wherein the setting portion reads a configuration of the input-and-output channel to be used from the input-and-output configuration information file and automatically sets an optional setting value in the system configuration information of the system configuration information file.

18. The information processing device according to claim 10, wherein when the comparing portion determines that the mounted hardware configuration does not satisfy requirements of the device configuration information file and/or the input-and-output configuration information file, the setting portion discontinues an automatic setting process of the system configuration information and outputs a message indicating a section lacking a hardware component.

19. A computer server including system configuration information, one or more processing devices and/or one or more input-and-output devices, the computer server comprising:
a storage unit that stores device and input-and-output configurations of the computer server; and
a service processor that executes:
automatically recognizing mounted hardware in the computer server,
comparing information on the mounted hardware with the device and input-and-output configurations, and
automatically setting and/or updating the system configuration information according to the device and input-and-output configuration files when the mounted hardware satisfies the device and input-and-output configurations.
